(19) United States
(12) Patent Application Publication
(10) Pub. No.: US 2017/0090181 A1
(43) Pub. Date: Mar. 30, 2017

(54) OPTICAL SCANNING ENDOSCOPE APPARATUS

(71) Applicant: OLYMPUS CORPORATION, Tokyo (JP)

(72) Inventor: Takeharu INNAMI, Tokyo (JP)

(73) Assignee: OLYMPUS CORPORATION, Tokyo (JP)

(21) Appl. No.: 15/359,025

(22) Filed: Nov. 22, 2016

Related U.S. Application Data
(63) Continuation of application No. PCT/JP2015/002684, filed on May 27, 2015.

(30) Foreign Application Priority Data
May 27, 2014 (JP) 2014-109221

(51) Int. Cl. G02B 23/24; G02B 26/10; H04N 5/225

(52) U.S. Cl. CPC G02B 23/2469; H04N 5/2256; G02B 26/103; H04N 2005/2255

(57) ABSTRACT

Provided is an optical scanning endoscope apparatus, including: an illumination optical fiber which guides light from a light source and has a leading end part oscillatably supported; a piezoelectric substrate designed to vibrate the leading end part of the illumination optical fiber in the Y-direction; piezoelectric substrates designed to vibrate the leading end part of the illumination optical fiber in the X-direction; a piezoelectric substrate which drives the leading end part of the illumination optical fiber such as to at least partially cancel out vibration components in the Y-direction generated by the piezoelectric substrates; and an optical system which irradiates light emitted from the illumination optical fiber, toward an observation object; a photodetector which detects light obtained by the observation object irradiated with the light and converts the light thus detected into an electric signal; and an image processor which generates an image based on the electric signal output by the photodetector.

### CROSS REFERENCE TO RELATED APPLICATIONS

The present application is a Continuing Application based on International Application PCT/JP2015/002684 filed on May 27, 2015, which, in turn, claims the priority from Japanese Patent Application No. 2014-109221 filed on May 27, 2014, the entire disclosure of these earlier applications being herein incorporated by reference.

### TECHNICAL FIELD

Disclosed is an optical scanning endoscope apparatus that scans an observation object with illumination light to perform observation.

### BACKGROUND

There has been developed in recent years optical scanning endoscope apparatuses which vibratory drive an oscillatably-supported fiber to scan illumination light emitted from an emitting end part of the fiber on an observation object and detects light reflected by or scattered on the observation object.

The aforementioned optical scanning endoscope apparatuses are configured to have the fiber run through a holding member having an inner hole for inserting the fiber therethrough, and to vibrately drive the holding member in a two-dimensional direction perpendicular to the fiber optical axis direction, to thereby two-dimensionally scan the illumination light on the observation object. The holding member is formed as, for example, a cubic ferrule having the longitudinal direction thereof in the optical axis direction of the fiber. The ferrule has piezoelectric elements disposed on four sides thereof along the longitudinal direction, which may be applied with vibration voltage, to thereby vibrate the fiber. Alternatively, the holding member may be configured as a columnar piezoelectric tube having an inner hole for inserting the fiber therethrough, which may have total four electrodes disposed around the fiber optical axis on the periphery of the piezoelectric tube at positions displaced by 90° from one another and may apply vibration voltage to the electrodes, to thereby vibrates the fiber (see, for example, JP2014036779A (PTL 1)).

### CITATION LIST

### Patent Literature

PTL 1: JP2014036779A

### SUMMARY

Meanwhile, a single mode optical fiber has a diameter on the order of 100 μm, and the holding member supporting the optical fiber is in a size on the order of several hundreds of micrometers in a direction perpendicular to the optical fiber axis. The holding member is so small that it causes manufacturing difficulty to accurately form the outer shape and arrange the position of the inner hole with as originally designed. Further, it again involves manufacturing difficulty to symmetrically attach piezoelectric elements when the holding member is formed as a ferrule, or to have piezoelectric elements accurately displaced by 90° from one another when the holding member is formed as a piezoelectric tube. Under such circumstances, the vibration of the fiber caused by piezoelectric elements opposing to each other across the fiber fails to be in an ideal direction, with the result that the two-dimensional scanning locus is distorted as deviated from an ideal scanning locus.

The above is explained with reference to FIGS. 9A to 11B. FIGS. 9A and 9B are diagrams illustrating an ideal sectional shape of an actuator and a first dimensional scanning pattern of the optical scanning endoscope apparatus, in which FIG. 9A is a sectional view of the actuator in the optical axis direction and FIG. 9B illustrates a scanning pattern when the actuator is driven in the X-direction. A fiber holding member 102 having a fiber 101 inserted therethrough is an elastic member having a rectangular parallelepiped shape which is square in section and extends in the fiber optical axis direction. The fiber holding member 102 has, on four sides thereof, piezoelectric substrates 103a to 103d, respectively, which are arranged symmetric. The piezoelectric substrates 103a to 103d are each formed of an electrode 103a₁ and the piezoelectric material 103a₂, as illustrated in relation to the piezoelectric substrate 103a (FIGS. 9A and 9B illustrates the electrode 103a₁ and the piezoelectric material 103a₂ only in relation to the piezoelectric substrate 103a, but the other piezoelectric substrates 103b to 103d are similarly configured). As described above, when the actuator is formed to have an ideal shape and arrangement of the piezoelectric substrates, the piezoelectric substrates 103b and 103d in the X-direction may be applied with vibration voltages different from each other in phase by 180 degrees, such that the leading end of the fiber 101 is one-dimensionally driven in the X-direction as illustrated in FIG. 9B. In FIG. 9A, the fiber holding member 102 and the fiber 101 are driven in the directions indicated by the arrows.

In contrast, the actuator manufactured in practice may be configured asymmetric as having the piezoelectric substrate 13b displaced in position, as illustrated in FIG. 10A. In such case, the piezoelectric substrates 103b and 103d in the X-direction generate, when applied with vibration voltage, undesired vibration components in the Y-direction apart from the vibration in the X-direction, which generates a scanning pattern inclined in the Y-direction as illustrated in FIG. 10B. As a result, the scanning pattern suffers distortion when the piezoelectric substrates 103b, 103d in the X-direction and the piezoelectric substrates 103a, 103c in the Y-direction are vibratory driven to perform a spiral scan or a Lissajous scan.

FIGS. 11A and 11B are diagrams for illustrating another example of an asymmetrically-configured actuator in practice of the disclosed optical scanning endoscope apparatus. In this case, as FIG. 11A illustrates a sectional view of the actuator in the optical axis direction, the fiber holding member 102 is out of the square shape. Accordingly, the piezoelectric substrate 103b has the normal oriented unparallel to the X-direction, and thus the piezoelectric substrates 103b, 103d generate vibration components in the Y-direction when applied with vibration voltage. As a result, the resulting scanning pattern is inclined in the Y-direction as illustrated in FIG. 11B, similarly to the pattern of FIG. 10B.

Further, the inclined scanning patterns shown in FIGS. 10B and 11B are generated by one-dimensional vibration; however, the unnecessary vibration in the Y-direction may generate phase shift, which may generate an elliptical scanning pattern. In such case, the scanning pattern is further distorted in shape when two-dimensional scanning is performed.

The disclosed optical scanning endoscope apparatus, includes:

a fiber which guides light from a light source and has a leading end part is oscillatably supported;

a first driver element designed to vibrate the leading end part of the fiber in a first direction;

a second driver element designed to vibrate the leading end part of the fiber in a second direction substantially perpendicular to the first direction;

a first vibration suppression element which drives the leading end part of the fiber such as to cancel out at least some vibration components in the first direction generated by the second driver element;

an optical system which irradiates light emitted from the fiber, toward an observation object;

a photodetector which detects light obtained by the observation object irradiated with the light and converts the light thus detected into an electric signal; and

an image processor which generates an image based on the electric signal output by the photodetector.

The first vibration suppression element may preferably be disposed opposing to the first driver element across the fiber.

Alternatively, the first vibration suppression element may be disposed on the same side or on the opposite side of the first driver element, along the fiber.

Further, the first driver element and the second driver element may drive the leading end part of the fiber to spiral scan, and the first vibration suppression element may be driven by a drive signal having a phase difference of 90° relative to a drive signal of the first driver element.

Alternatively, the first driver element and the second driver element may drive the leading end part of the fiber to Lissajous scan, and the first vibration suppression element may be driven by a drive signal having the same frequency as that of a drive signal of the second driver element.

Further, the optical scanning endoscope apparatus may further include a second vibration suppression element which drives the leading end part of the fiber such as to cancel out at least some vibration components in the second direction generated by the first driver element.

### BRIEF DESCRIPTION OF THE DRAWINGS

In the accompanying drawings:

FIG. 1 is a block diagram illustrating a schematic configuration of the disclosed optical scanning endoscope apparatus according to Embodiment 1;

FIG. 2 is an overview schematically illustrating a scope of the optical scanning endoscope apparatus of FIG. 1;

FIG. 3 is a sectional view of a tip part of the scope of FIG. 2;

FIGS. 4A and 4B are diagrams for illustrating a drive mechanism of the optical scanning endoscope apparatus, in which FIG. 4A is a side view of an actuator illustrated along with a block diagram of a drive controller, and FIG. 4B is a sectional view taken along the line A-A of FIG. 4A;

FIGS. 5A and 5B are graphs showing waveforms of voltages applied to piezoelectric substrates, in which FIG. 5A shows a waveform of a voltage applied to a piezoelectric substrate 28a, and FIG. 5B shows a waveform of a voltage applied to a piezoelectric substrate 28c;

FIG. 6 is a diagram for illustrating a drive mechanism of the disclosed optical scanning endoscope apparatus according to Embodiment 2;

FIGS. 7A and 7B are graphs showing waveforms of voltages applied to the piezoelectric substrates of FIG. 6, in which FIG. 7A shows a waveform of a voltage applied to a piezoelectric substrate 28b, and FIG. 7B shows a waveform of a voltage applied to a piezoelectric substrate 28c;

FIG. 8 is a diagram for illustrating an actuator of the disclosed optical scanning endoscope apparatus according to Embodiment 3;

FIGS. 9A and 9B are diagrams illustrating an ideal shape and scanning pattern of an actuator of an optical scanning endoscope apparatus, in which FIG. 9A is a sectional view of the actuator in the optical axis direction and FIG. 9B illustrates a scanning pattern when the actuator is driven in the X-direction;

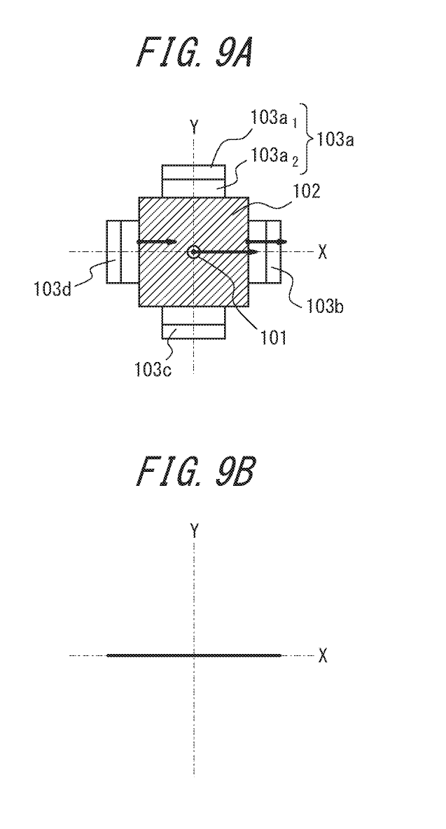

FIGS. 10A and 10B are diagrams for illustrating an example of an asymmetrically-configured actuator in practice of an optical scanning endoscope apparatus, in which FIG. 10A is a sectional view of the actuator in the optical axis direction, and FIG. 10B illustrates a scanning pattern when the actuator is driven in the X-direction; and

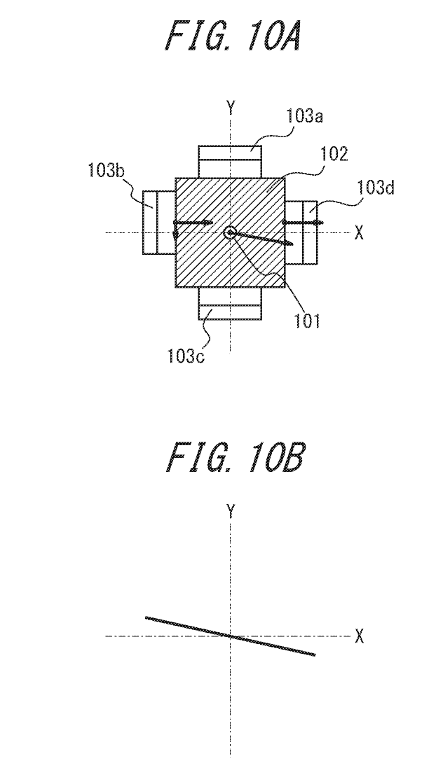

FIGS. 11A and 11B are diagrams for illustrating another example of an asymmetrically-configured actuator in practice of an optical scanning endoscope apparatus, in which FIG. 11A is a sectional view of the actuator in the optical axis direction, and FIG. 11B illustrates a scanning pattern when the actuator is driven in the X-direction.

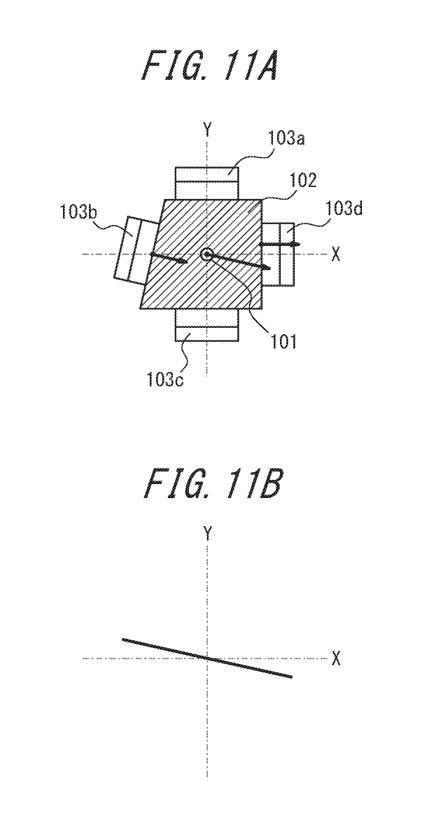

### DETAILED DESCRIPTION

Hereinafter, Embodiments of the disclosed apparatus will be illustrated with reference to the accompanying drawings.

### Embodiment 1

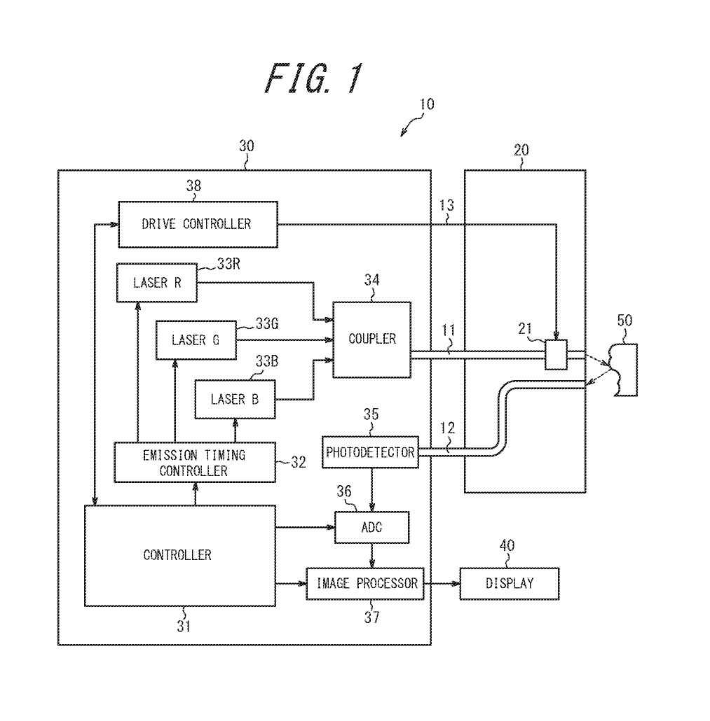

FIG. 1 is a block diagram illustrating a schematic configuration of the disclosed optical scanning endoscope apparatus according to Embodiment 1. The optical scanning endoscope apparatus 10 includes: a scope 20; a control device body 30; and a display 40.

The control device body 30 is configured by including: a controller 31 controlling the whole of the optical scanning endoscope apparatus 10; an emission timing controller 32; lasers 33R, 33G, 33B; and a coupler 34. The emission timing controller 32 controls, under the control of the controller 31, emission timing of the three lasers 33R, 33G, 33B emitting laser lights of three primary colors of red, green, and blue. The lasers 33R, 33G, 33B may use, for example, a diode pumped solid state (DPSS) laser and a laser diode. Laser lights emitted from the lasers 33R, 33G, 33B are multiplexed by the coupler 34, and caused to be incident on an illumination optical fiber 11 as a single mode fiber. Needless to say, the optical scanning endoscope apparatus 10 may employ, as the light source, one laser light source or a plurality of other light sources, without being limited to the aforementioned configuration. Further, the lasers 33R, 33G, 33B and the coupler 34 may be accommodated not in the control device body 30 but in another casing connected to the control device body 30 via a signal line.

The illumination optical fiber 11 is connected all the way to the tip part of the scope 20, and light incident on the illumination optical fiber 11 from the coupler 34 is guided through to the tip part of the scope 20 to be irradiated toward an observation object 50. At this time, an actuator 21 is vibratory driven, so as to allow illumination light emitted from the illumination optical fiber 11 to be two-dimensionally scanned on an observation surface of the observation object 50. The actuator 21 is controlled by a drive controller 38 to be described later of the control device body 30. The observation object 50 irradiated with illumination light generates signal light such as reflected light, scattered light, and fluorescence, which is received by the leading end of a detection optical fiber 12 formed of a plurality of multimode fibers and guided through inside the scope 20 to the control device body 30.

The control device body 30 further includes: a photodetector 35 for processing signal light; an analog-to-digital converter (ADC) 36; and an image processor 37. The photodetector 35 decomposes signal light having traveled through the detection optical fiber 12 into spectral components, and converts, by means of photodiodes or the like, each of the spectral components into an electric signal. The image signal thus converted into an electric signal is converted into a digital signal by the ADC 36, which outputs the digital signal to the image processor 37. The controller 31 calculates information on the scanning position on the scanning path, based on the drive start timing of vibration voltage applied by the drive controller 38 and information on the amplitude, the phase, and the like. Alternatively, the controller 31 obtains the information from a lookup table previously prepared. Then, the controller 31 passes the information thus calculated or obtained to the image processor 37. The image processor 37 obtains pixel data on the observation object 50 at the scanning position, based on a digital signal input from the ADC 36. The image processor 37 sequentially stores, in a memory (not shown), information on the scanning position and the pixel data, subjects the information to necessary processing such as interpolation processing after or during the scan to generate an image of the observation object 50, and displays the image on the display 40.

In each processing described above, the controller 31 synchronously controls the emission timing controller 32, the photodetector 35, the drive controller 38, and the image processor 37. Here, when generating an image by the image processor 37, the image to be generated will have distortion when the actual scanning locus of the illumination optical fiber is deviated from an ideal scanning locus. The disclosed apparatus includes a means for suppressing distortion in the scanning locus, as described in below.

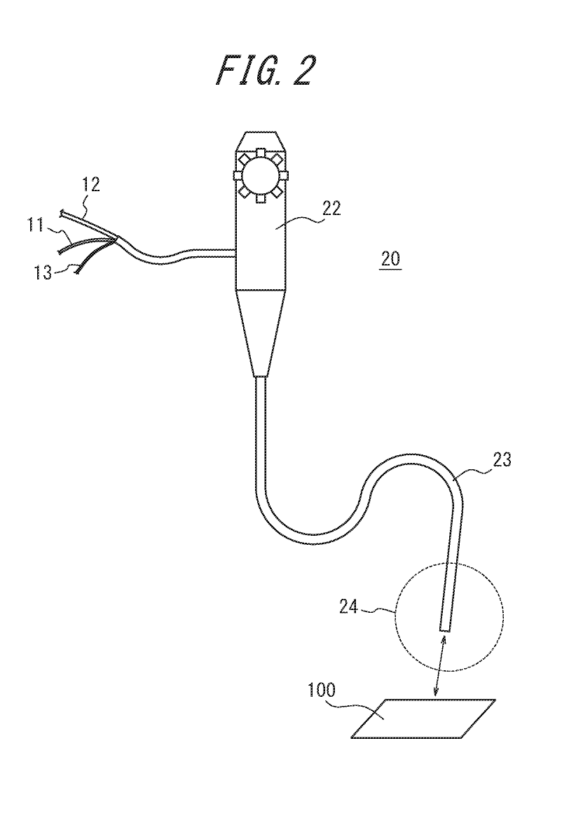

FIG. 2 is an overview schematically illustrating the scope 20. The scope 20 includes an operation portion 22 and an insertion portion 23. The operation portion 22 is connected with the illumination optical fiber 11, the detection optical fiber 12, and a wiring cable 13 from the control device body 30. The illumination optical fiber 11, the detection optical fiber 12, and the wiring cable 13 each run through inside the insertion portion 23 to be guided all the way to the tip part 24 (portion within the broken line of FIG. 2) of the insertion portion 23.

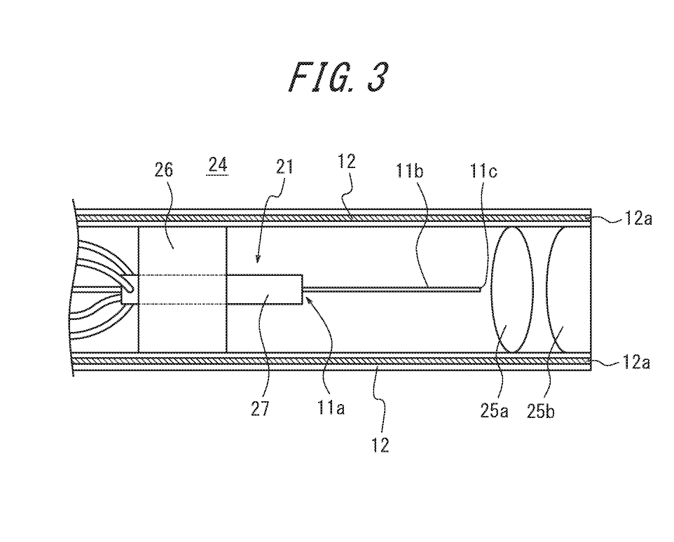

FIG. 3 is an enlarged sectional view of the tip part 24 of the insertion portion 23 of the scope 20 of FIG. 2. The tip part 24 is configured by including the actuator 21; illumination lenses 25a, 25b; the illumination optical fiber 11 running through the central part; and the detection optical fiber 12 running through the periphery.

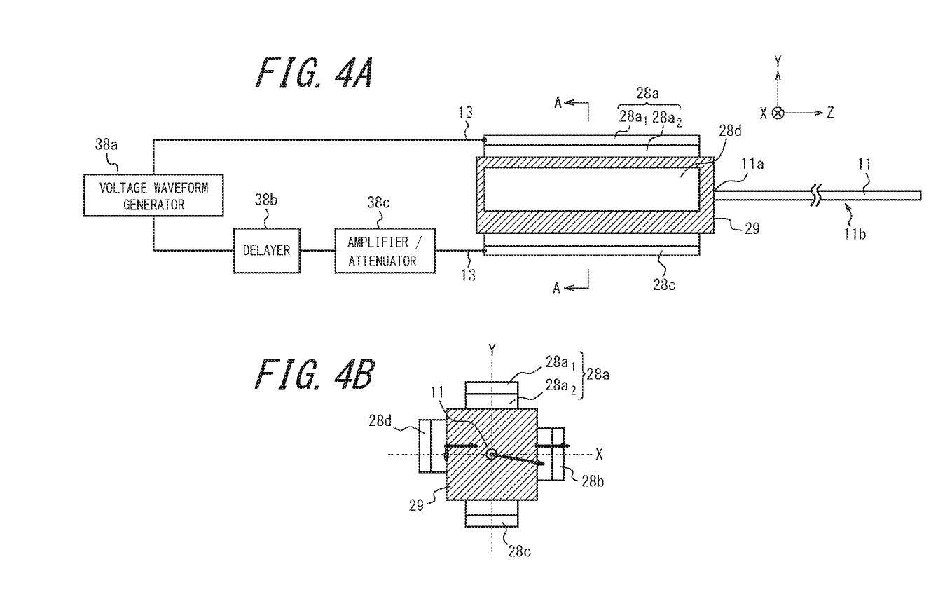

The actuator 21 is configured by including an actuator tube 27 fixed inside the insertion portion 23 of the scope 20 via an attachment ring 26; and a flexible fiber holding member 29 and the piezoelectric substrates 28a to 28d disposed inside the actuator tube 27 (see FIGS. 4A and 4B). Here, the piezoelectric substrate 28a is a first driver element, the piezoelectric substrates 28a, 28d each are a second driver element, and the piezoelectric substrate 28c is a first vibration suppression element. The illumination optical fiber 11 is supported by a fiber holding member 29, and has an oscillatably-supported oscillation part 11b (leading end part of the illumination optical fiber 11) defined between the fixed end 11a supported by the fiber holding member 29 and the emitting end 11c. Meanwhile, the detection optical fiber 12 is disposed to run through the periphery of the insertion portion 23, so as to extend to the end of the tip part 24. The detection optical fiber 12 further includes detection lens (not shown) disposed at the leading end part 12a of each fiber thereof.

Further, the illumination lenses 25a, 25b and the detection lens are disposed at the distal end of the tip part 24. The illumination lenses 25a, 25b are configured such that laser light emitted from the emitting end 11c of the illumination optical fiber 11 is substantially converged onto the observation object 50. Further, the detection lens captures light, as signal light, having been converged onto the observation object 50 and reflected, scattered, and refracted by the observation object 50 (light interacted with the observation object 50) or fluorescence, so as to converge and couple the light to the detection optical fiber 12 disposed behind the detection lens. The illumination lens may be formed of one lens or a plurality of other lenses, without being limited to the two-lens configuration.

FIGS. 4A and 4B are diagrams for illustrating a drive mechanism of the optical scanning endoscope apparatus 10, in which FIG. 4A is a side view of the actuator 21 illustrated along with a block diagram of the drive controller 38, and FIG. 4B is a sectional view taken along the line A-A of FIG. 4A. The illumination optical fiber 11 penetrates through the center of the fiber holding member 29 in a prism-like shape, so as to be fixed and held by the fiber holding member 29. The four sides of the fiber holding member 29 are each facing in the +Y-direction and the +X-direction and in the directions opposite thereto, respectively. Then, the fiber holding member 29 has a pair of the Y-direction driving piezoelectric substrates 28a, 28c fixed in the +Y-direction and the −Y-direction and a pair of the X-direction driving piezoelectric substrates 28b, 28d fixed in the +X-direction and the −X-direction. The piezoelectric substrates 28a to 28d have the wiring cable 13 connected thereto from the drive controller 38 of the control device body 30.

The piezoelectric substrates 28a to 28d are each formed of, as illustrated in FIGS. 4A, 4B showing the piezoelectric substrate 28a, an electrode a₁ and a piezoelectric material 28a₂ interposed between the electrode 28a₁ and the fiber holding member 29. Voltage may be applied across the electrode 28a₁ and the fiber holding member 29, so as to cause the piezoelectric material 28a₂ to be elongated and contracted in the optical axis direction of the illumination optical fiber 11. Due to the elongation of the piezoelectric material 28a₂, the fiber holding member 29 receives bending stress on the opposite side of the piezoelectric substrate 28a; due to the contraction of the piezoelectric material 28a₂, the fiber holding member 29 receives bending stress on the piezoelectric substrate 28a side. As a result, the illumination optical fiber 11 also receives bending stress in the same directions. The same applies to the other piezoelectric substrates 28b to 28d. The piezoelectric substrates 28b and 28d are generally applied with voltage such that the one is contracted while the other is elongated, in order to drive the illumination optical fiber 11 in the same direction. For example, the piezoelectric substrate 28b and the piezoelectric substrate 28d, when polarized in the same direction, are applied with voltages mutually inverted in phase by 180°. Alternatively, the piezoelectric substrate 28b and the piezoelectric substrate 28d, when polarized in the opposite directions, are applied with a voltage so as to provide a phase difference of 0°. Here, the phase difference between the piezoelectric substrate 28b and the piezoelectric substrate 28d is not necessarily be fixed to 180° or 0°, and may be configured to be finely adjustable therefrom. Further, the piezoelectric substrate 28b and the piezoelectric substrate 28d may desirably be arranged symmetric to each other about the XZ plane and also symmetric to each other about the YZ plane. However, referring to FIG. 4B, the piezoelectric substrate 28d is arranged as being displaced in the Y-direction due to errors in manufacture. As a result, the piezoelectric substrate 28d generates, when driven, unnecessary vibration in the Y-axis direction against the illumination optical fiber 11. Here, such displacement of the piezoelectric substrate 28d is illustrated as an exemplary cause of unnecessary vibration to be generated in the Y-direction by the piezoelectric substrates 28b, 28d disposed in the X-direction. Other than the above, unnecessary vibration in the Y-direction may potentially be caused by various reasons such as distortion in the shape of the fiber holding member 29 or positional displacement of the inner hole through which the fiber penetrates.

Described next is a method for driving the disclosed illumination optical fiber 11 according to Embodiment 1. The illumination optical fiber 11 is driven such that the tip end draws a spiral locus, so that the observation object 50 is scanned with illumination light in a spiral scanning pattern.

The optical scanning endoscope apparatus 10, immediately after the production or when not observing the observation object 50, measures a scanning pattern of the emitting end 11c of the illumination optical fiber 11 in order to adjust the scanning locus. Specifically, the tip end of the scope 20 is fixed, and a position sensitive detector (PSD) is disposed at a position where the illumination light emitted from the illumination optical fiber 11 is imaged by the illumination lenses 25a, 26b. The PSD is an optical sensor capable of detecting positions of a spot-like light on a two-dimensional plane. Next, the X-direction driving piezoelectric substrates 28b, 28d are applied with a sin wave voltage waveform to measure a scanning pattern, to thereby obtain data on the inclination of the vibration direction of the emitting end 11c of the illumination optical fiber 11, with respect to the X-direction. Based on the data on the inclination thus measured, an amplification/attenuation factor for the application voltage is calculated for canceling out unnecessary vibration generated in the Y-direction, with respect to the drive voltage of a spiral scan, and the factor is stored in the control device body 30. In general, the amplitude of unnecessary vibration in the Y-direction generated by the vibration in the X-direction is much smaller than the amplitude in the X-direction, and thus, the aforementioned amplification/attenuation factor is obtained as an attenuation factor.

Further, in the optical scanning endoscope apparatus 10, in order to spirally scan the illumination optical fiber 11, voltage waveform data on the Y-direction driving piezoelectric substrate 28a and on the X-direction driving piezoelectric substrates 28b, 28d is stored in advance in a lookup table. A single piezoelectric substrate 28a is used for Y-direction driving, while two piezoelectric substrates 28b and 28d are used for X-direction driving, and thus, the piezoelectric substrate 28a is larger in amplitude of the voltage waveform thereof. Further, the drive controller 38 of FIG. 1 includes a voltage waveform generator 38a, a delayer 38b, and an amplifier 38c of FIG. 4A. The voltage waveform generator 38a is connected to the piezoelectric substrates 28a, 28b, 28d via different wiring cables 13, and is configured to apply voltage waveforms generated according to the lookup table, to the respective piezoelectric substrates 28a, 28b, 28d. (In FIG. 4A, the wiring cables connected to the piezoelectric substrates 28b, 28d are omitted.)

Meanwhile, the voltage waveform generator 38a is connected to the piezoelectric substrate 28c via the delayer 38b and the amplifier/attenuator 38c. The voltage waveform generator 38a outputs the same voltage waveform as that of the drive voltage to be applied to the piezoelectric substrate 28a, in order to drive the piezoelectric substrate 28c. The delayer 38b is configured to delay, by 90°, the phase of the voltage waveform output from the voltage waveform generator 38a, and the amplifier/attenuator 38c is configured to amplify or attenuate the voltage waveform output from the delayer 38b. The amplitude of a voltage waveform is amplified or attenuated based on the aforementioned amplification/attenuation factor calculated in the optical scanning endoscope apparatus 10.

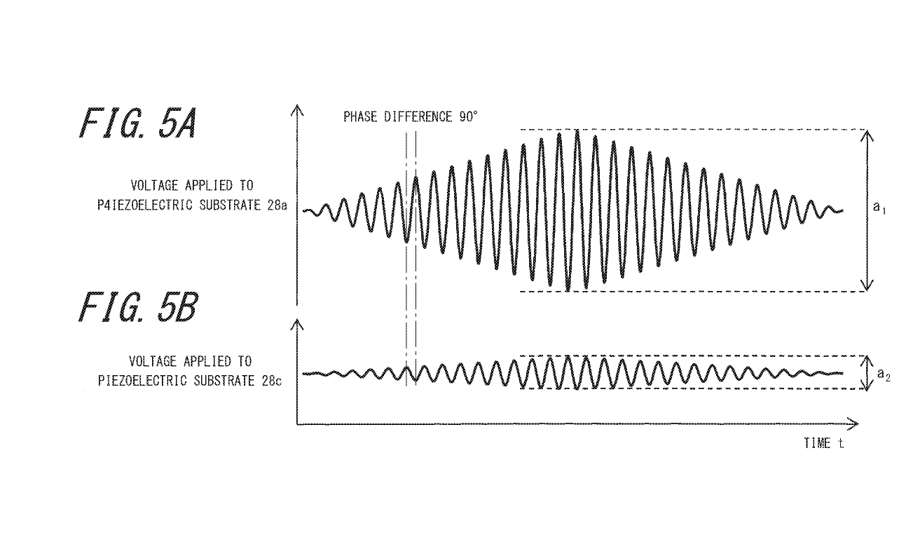

According to the aforementioned configuration and ex-ante adjustment, when observing the observation object 50 by the optical scanning endoscope apparatus 10, the piezoelectric substrate 28a is applied with a voltage having a waveform shown in FIG. 5A under the control of the drive controller 38. Further, similarly to the piezoelectric substrate 28a, the piezoelectric substrates 28b, 28d are each applied with a voltage with a waveform that increases/decreases in amplitude over time and are shifted in phase by 90° (not shown). Further, the piezoelectric substrate 28c opposing to the piezoelectric substrate 28a is applied with a voltage having a voltage waveform shifted in phase by 90° from the voltage applied to the piezoelectric substrate 28a and reduced in amplitude based on the attenuation factor, as illustrated in FIG. 5B. In this manner, unnecessary vibration components in the Y-direction generated by the application of vibration voltage to the piezoelectric substrates 28b and 28d are cancelled out, and thus a spiral scanning pattern with less distortion can be obtained. As a result, the locus of the scanning pattern is rendered as an ideal spiral pattern, allowing the image processor 37 to generate an image with less distortion, based on the position information calculated by the controller 31 or the position information stored in advance in a lookup table.

As described above, according to Embodiment 1, the optical scanning endoscope apparatus 10 is capable of driving the illumination optical fiber 11 from directions substantially perpendicular to each other and suppressing distortion in the scanning pattern of the optical scanning endoscope apparatus 10. Therefore, there is no need to provide five or more piezoelectric substrates for driving and the fiber holding member 29 is substantially in a square prism shape in section, which can be processed with ease and produced at low cost. Further, forces acted by the piezoelectric substrates 28a to 28d are in directions substantially perpendicular to each other, and thus vibration of the emitting end 11c of the illumination optical fiber 11 can be controlled with ease.

Here, instead of using both the piezoelectric substrates 28b, 28d for X-direction driving, for example, the piezoelectric substrate 28b may be used as an driver element for use in X-direction vibration driving while using the piezoelectric substrate 28d as a second vibration suppression element canceling out at least some vibration components in the X-direction generated by the Y-direction vibration driving of the piezoelectric substrate 28a. In this case, similarly to the aforementioned method of driving the aforementioned piezoelectric substrate 28c, unnecessary vibration components in the X-direction generated by the vibration driving in the Y-direction by the piezoelectric substrate 28a are measured using a PSD, immediately after the production of the optical scanning endoscope apparatus 10 or when not observing the observation object 50. Then, when measuring the observation object 50, a voltage waveform to be applied to the piezoelectric substrate 28b is shifted in phase by 90°, and applies, to the piezoelectric substrate 28d, a signal attenuated in amplitude based on the measurement result. In this manner, unnecessary vibration components in the X-direction can also be suppressed, making it possible to obtain a more precise spiral scanning pattern.

### Embodiment 2

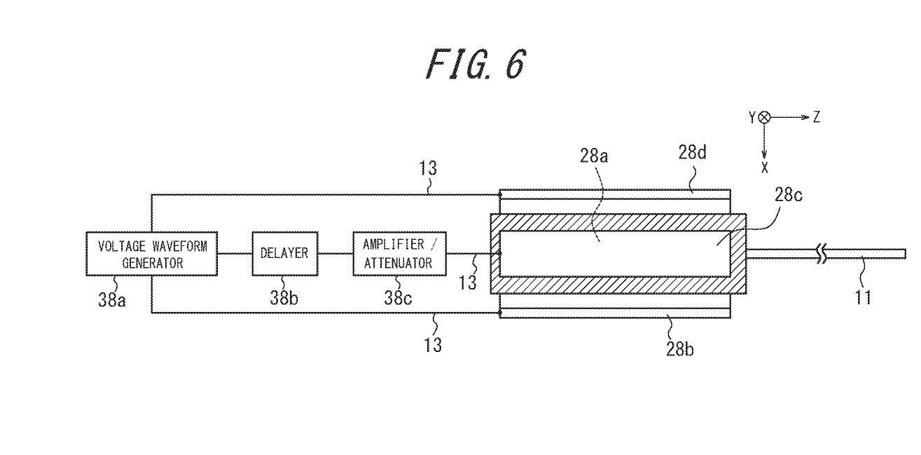

FIG. 6 is a diagram for illustrating a drive mechanism of the disclosed optical scanning endoscope apparatus according to Embodiment 2, showing a bottom view of the actuator 21 along with a block diagram of the drive controller 38. Unlike Embodiment 1, Embodiment 2 causes illumination light emitted from the illumination optical fiber 11 to be Lissajous scanned on the observation object 50. Therefore, the block diagram of the drive controller 38 is different from that of Embodiment 1, while the rest of the components are similar in configuration to those of Embodiment 1. Described in below is a method of scanning the observation object 50 according to Embodiment 2.

Similarly to Embodiment 1, the optical scanning endoscope apparatus of Embodiment 2 uses PSD to measure, immediately after the production of the optical scanning endoscope apparatus 10 or when not observing the observation object 50, unnecessary vibration components generated in the Y-direction when the X-direction driving piezoelectric substrates 28b, 28d are applied with vibration voltages, calculates the amplification/attenuation factor of an application voltage for cancelling out unnecessary vibration generated in the Y-direction, and stores the factor in the control device body 30. Further, when the unnecessary vibration generated in the Y-direction is phase shifted from the driving voltage applied to the piezoelectric substrates 28b, 28d, such phase shift is also stored in the control device body 30.

Further, the optical scanning endoscope apparatus 10 stores in advance, in a lookup table, voltage waveform data for the Y-direction driving piezoelectric substrate 28a, and for the X-direction driving piezoelectric substrates 28b, 28d, in order to Lissajous scan the illumination optical fiber 11. Further, the drive controller 38 of FIG. 1 includes the voltage waveform generator 38a, the delayer 38b, and the amplifier 38c of FIG. 6. The voltage waveform generator 38a is connected to the piezoelectric substrates 28a, 28b, 28d via different wiring cables 13, and is configured to apply waveforms generated based on the lookup table, to the respective piezoelectric substrates 28a, 28b, 28d. In FIG. 6, the wiring cable 13 connecting between the voltage waveform generator 38a and the piezoelectric substrate 28a is omitted. Meanwhile, in Embodiment 2, unlike Embodiment 1, the delayer 38b is configured to delay the phase of a voltage waveform applied from the voltage waveform generator 38a to the piezoelectric substrate 38b, and the amplifier/attenuator 38c is configured to amplify or attenuate the voltage waveform output from the delayer 38b, based on the amplification/attenuation factor calculated as above.

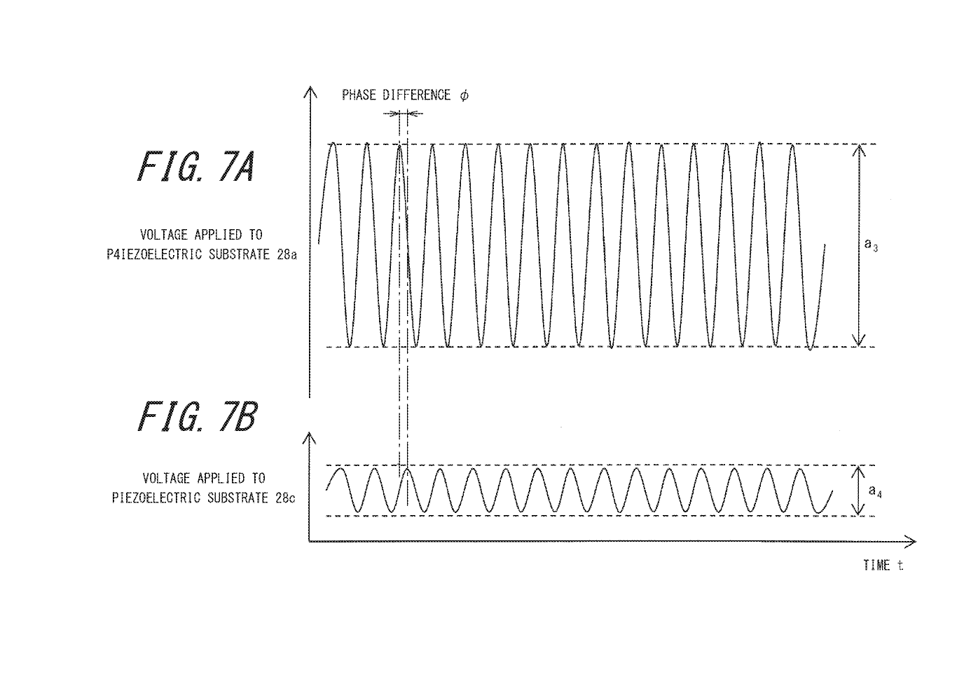

According to the aforementioned configuration and ex-ante adjustment, when observing the observation object 50 by the optical scanning endoscope apparatus 10, voltage of a waveform shown in FIG. 7A is applied to the piezoelectric substrate 28b while applying a voltage with a waveform reversed in phase to the piezoelectric substrate 28b under the control of the drive controller 38. Further, for Lissajous scan, the piezoelectric substrate 28a is applied with a sin wave voltage different in frequency from those applied to the piezoelectric substrates 28b, 28d. Here, the respective frequencies are set to be in an integer ratio to one another. Further, the piezoelectric substrate 28c opposing to the piezoelectric substrate 28a is applied with a voltage shifted in phase by a phase difference φ, based on the measured phase shift, from the voltage applied to the piezoelectric substrate 28b and attenuated in amplitude, as illustrated in FIG. 7B. In this manner, unnecessary vibration components in the Y-direction generated by the application of vibration voltage to the piezoelectric substrates 28b and 28d are cancelled out, and thus a Lissajous scanning pattern with less distortion can be obtained, allowing the image processor 37 to generate an image with less distortion as in Embodiment 1. Further, similarly to Embodiment 1, the fiber holding member 29 can be processed with ease and produced at low cost, while providing an effect of facilitating control of the vibration of the emitting end 11c of the illumination optical fiber 11.

### Embodiment 3

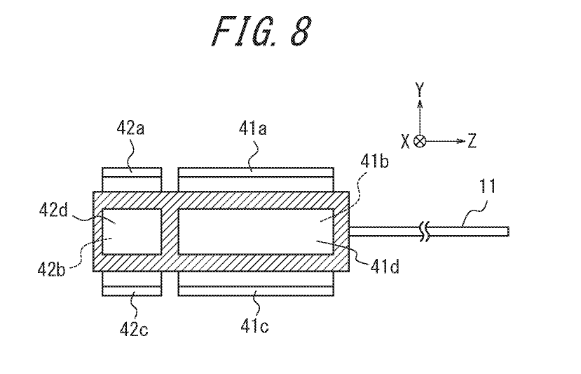

FIG. 8 is a diagram for illustrating an actuator of the disclosed optical scanning endoscope apparatus according to Embodiment 3. In Embodiments 1 and 2 above, the piezoelectric substrates 28a to 28d are disposed one by one on each of the four sides of the fiber holding member 29, while in Embodiment 3, two piezoelectric substrates are disposed at a time on each of the four sides of the fiber holding member 29 along the longitudinal direction thereof. Piezoelectric substrates 41a and 41c are Y-direction driving driver elements (first driver elements), which are applied with voltage of reversed phase by the drive controller 38, so that the one is elongated while the other is contracted. On the other hand, the piezoelectric substrates 41b and 41d are X-direction driving driver elements (second driver elements), and applied, similarly to the piezoelectric substrates 41a and 41c, with a voltage of reversed phase so that one of them is elongated while the other is contracted.

In contrast, the piezoelectric substrates 42a, 42c are first vibration suppression elements disposed for cancelling out at least some unnecessary vibration components in the Y-direction generated along with the vibration driving in the X-direction by the piezoelectric substrates 41b, 41d, and the piezoelectric substrates 42b, 42d are second vibration suppression elements disposed for at least partially cancelling out unnecessary vibration components in the X-direction generated along with the vibration driving in the Y-direction by the piezoelectric substrates 41a, 41c. The piezoelectric substrates 42a, 42c are applied with signals mutually reversed in phase, and the piezoelectric substrates 42b and 42d are also applied with signals mutually reversed in phase.

Similarly to Embodiment 1 and Embodiment 2, prior to observing an image of the observation object 50, unnecessary vibration components to be generated when the the emitting end 11c of the illumination optical fiber 11 is one-dimensionally driven in the X-direction or the Y-direction using the piezoelectric substrates 41a to 41d for use in vibration driving are measured, and a voltage waveform to be applied to the piezoelectric substrates 41a to 42d for use in vibration suppression is determined based on the measured data. For use in spiral scanning, in image observation of the optical scanning endoscope apparatus 10, a driving voltage waveform of the piezoelectric substrates 41a, 41c is given a phase delay of 90° so as to be attenuated by the attenuation factor previously calculated by the aforementioned measurement, which is applied to the piezoelectric substrates 42a, 42c, to thereby suppress unnecessary vibration components in the Y-direction. Unnecessary vibration components in the X-direction can also be suppressed in a similar manner. Similarly to Embodiment 1 and Embodiment 2, the drive controller 38 has such components as the voltage waveform generator 38a, the delayer 38b, and the amplifier/attenuator 38c, and is connected to each of the piezoelectric substrates 41a to 41d, 42a to 42d via the wiring cables 13, which are however omitted from FIG. 6.

According to Embodiment 2, two each of the piezoelectric substrates 41a to 41d opposing to each other are employed for X-direction driving and the Y-direction driving, so that the illumination optical fiber 11 is applied with symmetric forces to provide a stable locus. In addition thereto, the piezoelectric substrates 42a to 42d for cancelling out unnecessary vibrations are further disposed along the illumination optical fiber 11, which allows for suppressing distortion in the scanning pattern.

Note that the disclosed apparatus may be subjected to various modifications and alterations without being limited Embodiments above. For example, an amplifier/attenuator is used in Embodiment 1 and Embodiment 2 for adjusting the amplitude of the piezoelectric substrate for vibration suppression (vibration suppression element), which may be replaced by another piezoelectric substrate with elongation/contraction property to adjust the amplitude, rather than a piezoelectric substrate for driving (driver element).

Further, in the disclosed apparatus, the first driver element is disposed in one of at least two directions perpendicular to each other of the four directions displaced from one another by 90°, while the second driver element is disposed in the other direction, while disposing the first vibration suppression element on the same side or on the opposite side of the first driver element. Accordingly, other than the aforementioned Embodiments, various arrangements are possible for the driver element and the vibration suppression element. For example, Embodiment 1 may also be configured to only include the piezoelectric substrate 28a (first driver element), the piezoelectric substrate 28b (second driver element), and the piezoelectric substrate 28c (first vibration suppression element), without including the piezoelectric substrate 28d. Alternatively, Embodiment 3 may only use the piezoelectric substrate 42a (first vibration suppression element) and the piezoelectric substrate 42d (second vibration suppression element) to cancel out unnecessary vibration components, without including the piezoelectric substrates 42c, 42d.

Further, the disclosed apparatus, which uses piezoelectric substrates as a driver element and a vibration suppression element, may also be applied to an optical scanning endoscope apparatus having an electromagnetic actuator using a magnet and an electromagnetic coil, as means for driving the illumination optical fiber.

### REFERENCE SIGNS LIST

10 optical scanning endoscope apparatus
11 illumination optical fiber
11a fixed end
11b oscillation part
11c emitting end
12 detection optical fiber
13 wiring cable
20 scope
21 actuator
22 operation portion
23 insertion portion
24 tip part
25a, 25b illumination lens
26 attachment ring
27 actuator tube
28a to 28d piezoelectric substrate
29 fiber holding member
30 control device body
31 controller
32 emission timing controller
33R, 33G, 33B laser
34 coupler
35 photodetector
36 ADC
37 image processor
38 drive controller
40 display
50 observation object

1. An optical scanning endoscope apparatus, comprising:
a fiber which guides light from a light source and has a leading end part is oscillatably supported;
a first driver element designed to vibrate the leading end part of the fiber in a first direction;
a second driver element designed to vibrate the leading end part of the fiber in a second direction substantially perpendicular to the first direction;
a first vibration suppression element which drives the leading end part of the fiber such as to cancel out at least some vibration components in the first direction generated by the second driver element;
an optical system which irradiates light emitted from the fiber, toward an observation object;
a photodetector which detects light obtained by the observation object irradiated with the light and converts the light thus detected into an electric signal; and
an image processor which generates an image based on the electric signal output by the photodetector.

2. The optical scanning endoscope apparatus according to claim 1, wherein the first vibration suppression element is disposed opposing to the first driver element across the fiber.

3. The optical scanning endoscope apparatus according to claim 1, wherein the first vibration suppression element is disposed on the same side or on the opposite side of the first driver element, along the fiber.

4. The optical scanning endoscope apparatus according to claim 1, wherein the first driver element and the second driver element are driven such as to spiral scan the leading end part of the fiber, and the first vibration suppression element is driven by a drive signal having a phase difference of 90° relative to a drive signal of the first driver element.

5. The optical scanning endoscope apparatus according to claim 1, wherein the first driver element and the second driver element drive the leading end part of the fiber to Lissajous scan, and the first vibration suppression element is driven by a drive signal having the same frequency as that of a drive signal of the second driver element.

6. The optical scanning endoscope apparatus according to claim 1, further comprising a second vibration suppression element which drives the leading end part of the fiber such as to cancel out at least some vibration components in the second direction generated by the first driver element.
